(19) United States
(12) Patent Application Publication
(10) Pub. No.: US 2015/0254229 A1
(43) Pub. Date: Sep. 10, 2015

(54) Computer-Implemented Systems and Methods for Evaluating Use of Source Material in Essays

(71) Applicant: Educational Testing Service, Princeton, NJ (US)

(72) Inventors: Beata Beigman Klebanov, Hamilton, NJ (US); Nitin Madnani, Princeton, NJ (US); Jill Burstein, Princeton, NJ (US); Swapna Somasundaran, Plainsboro, NJ (US)

(21) Appl. No.: 14/640,121

(22) Filed: Mar. 6, 2015

Related U.S. Application Data
(60) Provisional application No. 61/949,565, filed on Mar. 7, 2014.

(51) Int. Cl. G06F 17/27; G09B 7/02; G09B 5/06

(52) U.S. Cl. CPC G06F 17/2765; G09B 5/06; G09B 7/02

(57) ABSTRACT

Systems and methods are provided for a computer-implemented method of providing a score that measures an essay's usage of source material provided in at least one written text and an audio recording. Using one or more data processors, a determination is made of a list of n-grams present in a received essay. For each of a plurality of present n-grams, an n-gram weight is determined, where the n-gram weight is based on a number of appearances of that n-gram in the at least one written text and a number of appearances of that n-gram in the audio recording, and an n-gram sub-metric is determined based on the presence of the n-gram in the essay and the n-gram weight. A source usage metric is determined based on the n-gram sub-metrics for the plurality of present n-grams, and a scoring model is used to generate a score for the essay based on the source usage metric.

### CROSS-REFERENCE TO RELATED APPLICATIONS

This application claims priority to U.S. Provisional Patent Application No. 61/949,565, filed Mar. 7, 2014, entitled “Content Importance Models for Scoring Writing from Sources,” which is incorporated herein by reference in its entirety.

### FIELD

The technology described in this patent document relates generally to essay scoring and more particularly to evaluating the use of source materials in essays.

### BACKGROUND

Selection and integration of information from external sources is an important academic and life skill. Secondary-level students are often required to gather relevant information from multiple sources, assess the credibility and accuracy of each source, and integrate the information. Such sources may include one or more text sources, and in some instances further include a spoken source (e.g., a lecturer speaking or an audio or video recording that includes a person speaking) It is desirable to test people's ability to properly incorporate source materials into a generated text, such as an essay.

### SUMMARY

Systems and methods are provided for a computer-implemented method of providing a score that measures an essay's usage of source material provided in at least one written text and an audio recording. Using one or more data processors, a determination is made of a list of n-grams present in a received essay. For each of a plurality of present n-grams, an n-gram weight is determined, where the n-gram weight is based on a number of appearances of that n-gram in the at least one written text and a number of appearances of that n-gram in the audio recording, and an n-gram sub-metric is determined based on the presence of the n-gram in the essay and the n-gram weight. A source usage metric is determined based on the n-gram sub-metrics for the plurality of present n-grams, and a scoring model is used to generate a score for the essay based on the source usage metric.

As an another example, a computer-implemented system for providing a score that measures an essay's usage of source material provided in at least one written text and an audio recording includes a processing system and a non-transitory computer-readable medium encoded to contain instructions for commanding the execute steps of a method. In the method, a determination is made of a list of n-grams present in a received essay. For each of a plurality of present n-grams, an n-gram weight is determined, where the n-gram weight is based on a number of appearances of that n-gram in the at least one written text and a number of appearances of that n-gram in the audio recording, and an n-gram sub-metric is determined based on the presence of the n-gram in the essay and the n-gram weight. A source usage metric is determined based on the n-gram sub-metrics for the plurality of present n-grams, and a scoring model is used to generate a score for the essay based on the source usage metric.

As a further example, a non-transitory computer-readable medium is encoded with instructions for commanding a processing system to execute a method of providing a score that measures an essay's usage of source material provided in at least one written text and an audio recording. In the method, a determination is made of a list of n-grams present in a received essay. For each of a plurality of present n-grams, an n-gram weight is determined, where the n-gram weight is based on a number of appearances of that n-gram in the at least one written text and a number of appearances of that n-gram in the audio recording, and an n-gram sub-metric is determined based on the presence of the n-gram in the essay and the n-gram weight. A source usage metric is determined based on the n-gram sub-metrics for the plurality of present n-grams, and a scoring model is used to generate a score for the essay based on the source usage metric.

### BRIEF DESCRIPTION OF THE DRAWINGS

FIG. 1 is a block diagram depicting a computer-implemented source material usage evaluation engine.

FIG. 2 is a diagram depicting example modules of a computer-implemented source material usage evaluation engine.

FIG. 3 is a diagram depicting an example source material determination module configured to calculate first and second source usage metrics.

FIG. 4 is a block diagram depicting a computer-implemented source material usage evaluation engine that transforms source usage metrics and other metrics into an essay score.

FIG. 5 is a diagram depicting example source usage metrics and training essay metrics that can be transformed by a scoring model into an essay score that measures the essay's usage of source material.

FIG. 6 is a flow diagram depicting a computer-implemented method of providing a score that measures an essay's usage of source material provided in at least one written text and an audio recording.

FIGS. 7A, 7B, and 7C depict example systems for implementing the approaches described herein for generating a source usage score for essays.

### DETAILED DESCRIPTION

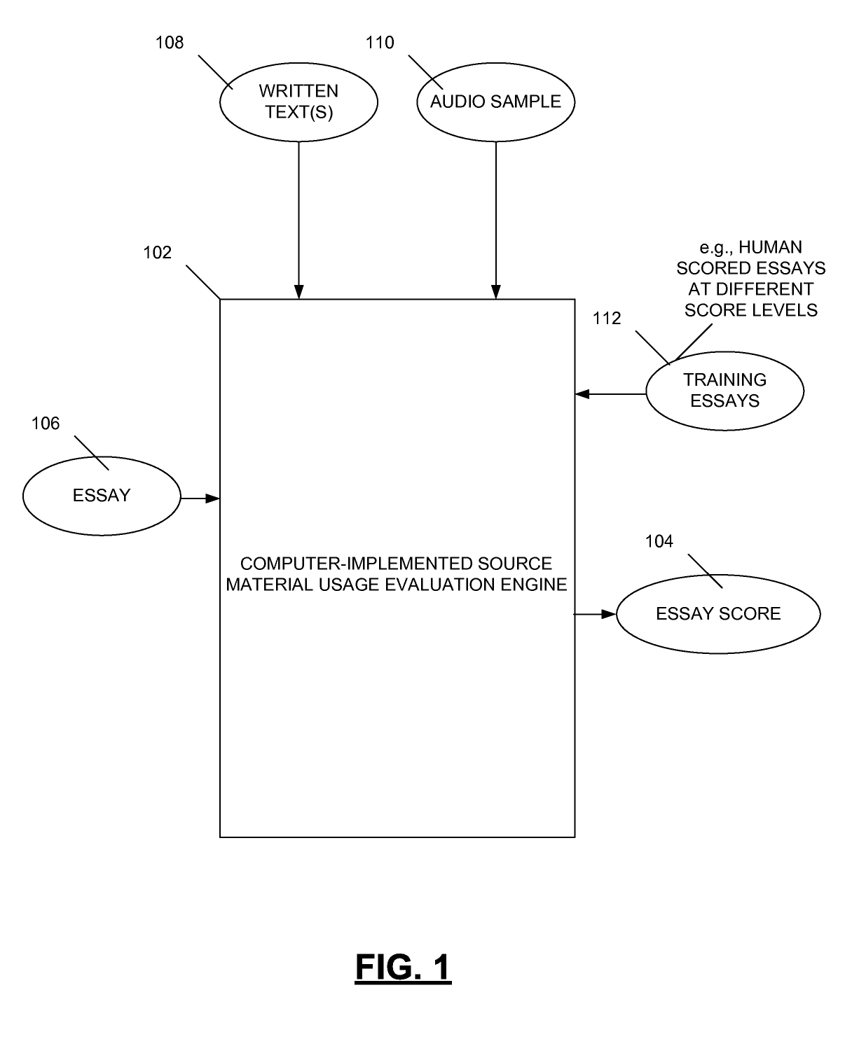

FIG. 1 is a block diagram depicting a computer-implemented source material usage evaluation engine. The engine 102, in one embodiment, is configured to provide an essay score 104 in an examination context, where an examinee is asked to provide an essay 106 on a topic that utilizes source materials that are provided to the examinee. For instance, an examinee can be provided a set of one or more reading passages on a topic and a recording of a lecturer discussing the topic from a different point of view. A prompt requests that the examinee provide an essay that summarizes the points made in the lecture, explaining how those points cast doubt on points made in the reading passages. Upon receipt of the essay 106, the engine 102 is configured to automatically provide an appropriate essay score 104 that approximates a score that would be provided by a human scorer.

With reference to the example system of FIG. 1, the examinee is provided one or more written texts 108 related to the topic as source material to use and possibly include in the essay 106. The examinee may further be provided a source that includes a person speaking on the topic. In the example of FIG. 1, that source is an audio recording or a video recording 110 that includes audio of the person speaking on the topic. In another example, a person speaks on the topic live to the examinee (e.g., in person, streamed). The source material usage evaluation engine 102 receives the examinee essay 106, the written texts 108, and the audio recording 110 and generates the essay score 104 based on those inputs. The engine 102 may further consider a set of training essays 112, such as human-scored essays written in response to the same prompt and source materials 108, 110 as the examinee essay 106, in generating the essay score 104.

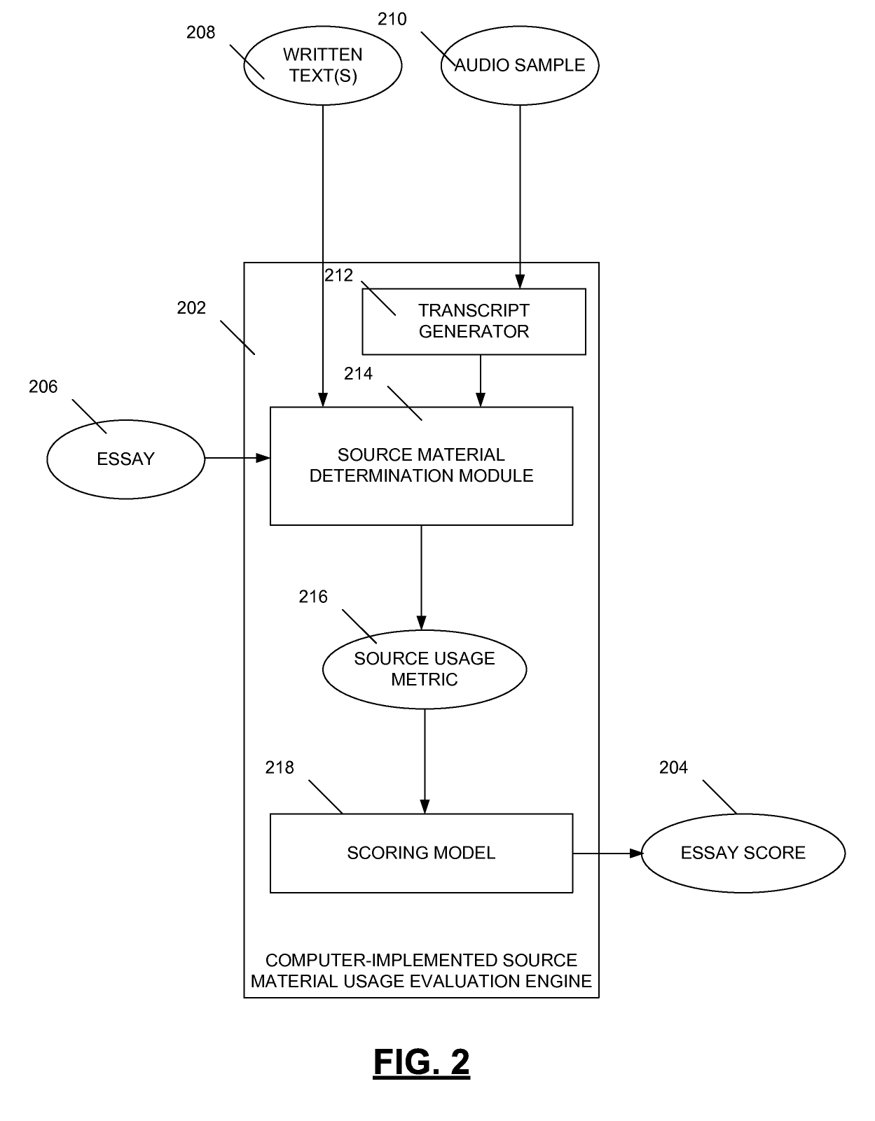

FIG. 2 is a diagram depicting example modules of a computer-implemented source material usage evaluation engine. The computer-implemented source material usage evaluation engine 202 is configured to use one or more data processors to generate an essay score 204 based on a received essay 206. The source material usage evaluation engine 202 receives the one or more written texts 208 and the audio recording 210 that were provided to the examinee for use in generating the essay 206. The engine utilizes a computer-implemented transcript generator 212, such as an automatic speech recognizer, to generate a transcript of the speech within the audio recording 210. The transcript from 212 as well as the written texts 208 are provided by a source material determination module 214 that transforms its received inputs (e.g., the depicted inputs and possibly additional inputs) into at least one source usage metric 216 that characterizes the quality of the essay's incorporation of the source materials 208, 210. The source usage metric 216 is transformed, alone or in combination with other metrics, by a scoring model 218 into the essay score 204.

In one example, the source usage metric 216 is based on an amount of overlap (e.g., single words (1-grams or unigrams), pairs of adjacent words (2-grams or bigrams), sets of three adjacent words (3-grams or trigrams), etc.) between the essay 206 and the transcript of the audio sample 210. For each n-gram in the essay 206 that overlaps with an n-gram in one or more of the written texts 208 and the audio sample 210, a sub-metric value is assigned, where the source usage metric 216 is determined based on the sub-metrics determined for individual n-grams (e.g., based on a sum of sub-metrics, a sum of sub-metrics normalized based on a length of one or more of the essay 206, the written texts 208, and the audio sample 210). Sub-metric values for n-grams appearing in the written texts 208 or the audio sample 210 can be pre-computed and stored in a computer-readable medium, such as a lookup table, where sub-metric values for n-grams in the essay 206 are accessed from the computer-readable medium to compute the source usage metric 216. In another example, sub-metric values are calculated on the fly for n-grams identified in the essay 206 based on the appearance of those essay n-grams in the written texts 208 and/or the audio sample 210.

Certain types and amounts of use of terminology and phrases from the source materials 208, 210 can be indicative of essay quality. In one embodiment, essay scores 204 are provided on a scale of 1 to 5. A score of 5 is given when an essay successfully selects the important information from the essay and text. A score of 4 is given when the essay is generally good in selecting the important information but includes a minor omission. A score of 3 is given when an essay contains some important information but omits a major point. A 2 score indicates that the essay contains some relevant information but omits or misrepresents important points. A score of 1 is provided when little or no meaningful or relevant coherent content from the source materials is included in the essay.

Source usage metrics 216 can take a variety of forms. The following indicates four example source usage metrics:
A first source usage metric counts overlaps of essay n-grams with n-grams in the written texts 208 and/or the transcript of the audio sample 210, with each overlap being counted equally. In one embodiment, this source usage metric is determined using bigrams. The essay is represented as a list (meaning including duplicates) E of bigrams. The transcript is represented as a set (not including duplicates) L of bigrams. A list B2 is calculated as bigrams in list E that are also in L. The first metric F1, in one example, measures the total number of bigrams in the essay that are shared with the audio recording transcript, normalized by essay length: F1=(total number of elements in list B2)/(essay length);
   A second source usage metric is based on essay n-gram overlap that is overlap with the audio sample 210 transcript versus overlap with the written text 208. In one embodiment, this source usage metric is determined using quadgrams. The audio recording transcript is represented as a set L of quadgrams. The written text is represented as a set R of quadgrams, and the essay is represented as a list E of quadgrams. A list B4 is calculated as quadgrams from list E that are also in set L. The second metric F2, in one example, is calculated by initially setting it to zero. For each quadgram y in B4, if y is not in set R, then increment F2 by 1. If y is in R, then increment F2 by K, where K is equal to (the number of occurrences of the quadgram y in the lecture)−(the number of occurrences of the quadgram y in the reading). In this example, this feature F2 credits occurrence of quadgrams that are distinctive to the audio recording transcript and detracts from the score in cases where a quadgram did occur in the transcript but is actually more pertinent to the reading. Quadgrams that occur the same number of times in the reading and in the lecture are ignored;
A third source usage metric is based on counts of appearances of terms from the essay in the audio sample transcript normalized by the length of the audio sample transcript, providing an MLE estimate of the probability that a term in the essay appears in the lecture. In one embodiment, this source usage metric is determined using trigrams. This metric, in one embodiment, is determined in a similar fashion to the second source usage metric, where for each trigram in a list containing trigrams that appear in the essay that also appear in a set of trigrams in the audio recording transcript is stored in a list B5. The third metric F3 is calculated by initially setting F3 to zero and incrementing F3 by 1 for each trigram in list B5; and
A fourth source usage metric is based on a position in the audio sample transcript where a first match with an n-gram in the essay is found (e.g., position of first match in transcript/length of transcript). In one embodiment, this source usage metric is calculated using bigrams or trigrams. In one example, this source usage metric is normalized based on a length of the transcript. This metric weights overlap that occurs later in the transcript more than overlap that occurs early in the transcript. In an alternative embodiment, overlap that occurs earlier is weighted more than overlap that occurs later in the transcript.

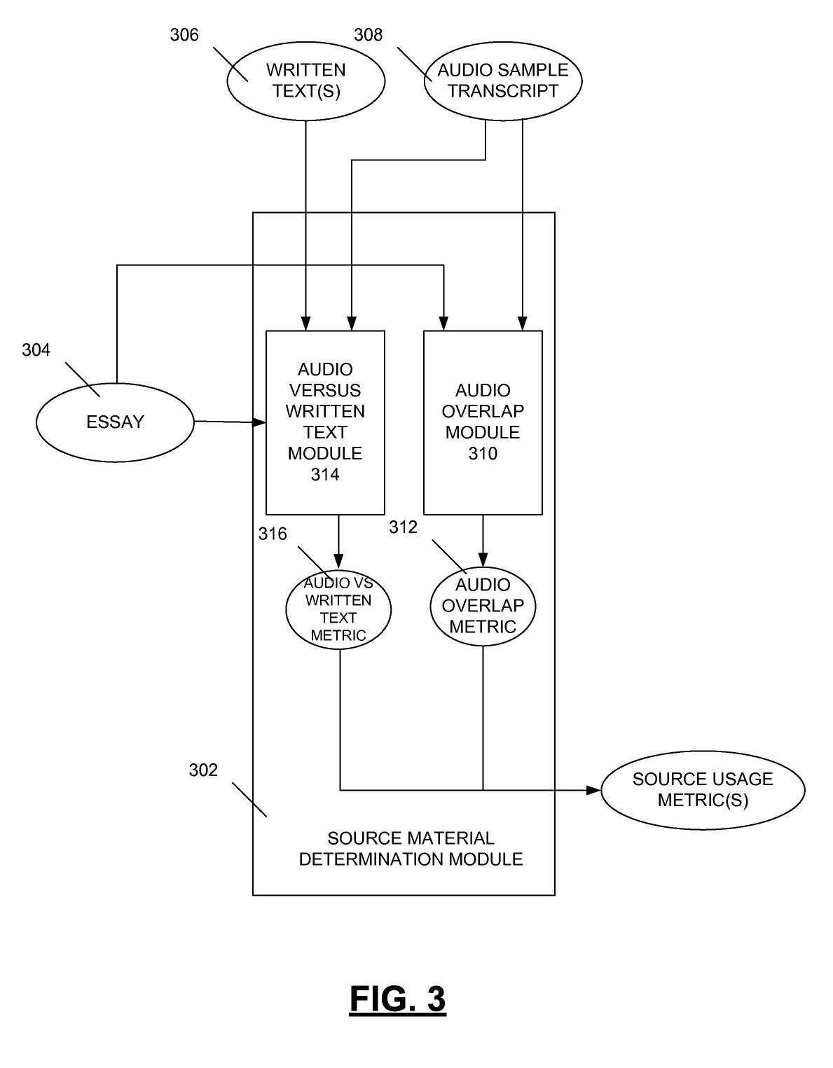

FIG. 3 is a diagram depicting an example source material determination module configured to calculate the first and second source usage metric described above. The module 302 receives the essay 304 to be scored along with the written text 306 and the audio sample transcript 308 source materials. The audio overlap module 310 is configured to transform the essay 304 and the audio sample transcript 308 (and possibly other factors) into an audio overlap metric 312. The audio overlap metric 312 is a flavor of the first source usage metric described above that measures an amount of n-gram overlap between the essay 304 and the words of the audio sample as represented in the audio sample transcript 308. An audio versus written text module 314 is configured to transform the essay 304, the written texts 306, and the audio sample transcript 308 and possibly other factors into an audio versus written text metric 316. The audio versus written text metric 316 is a flavor of the second source usage metric described above that measures overlap of n-grams in the essay to n-grams in the written texts 306 and the audio sample transcript 308. The source material determination module 302 outputs the determined metrics 312, 316 as source usage metrics 320 that are provided to a scoring model for generation of an essay score.

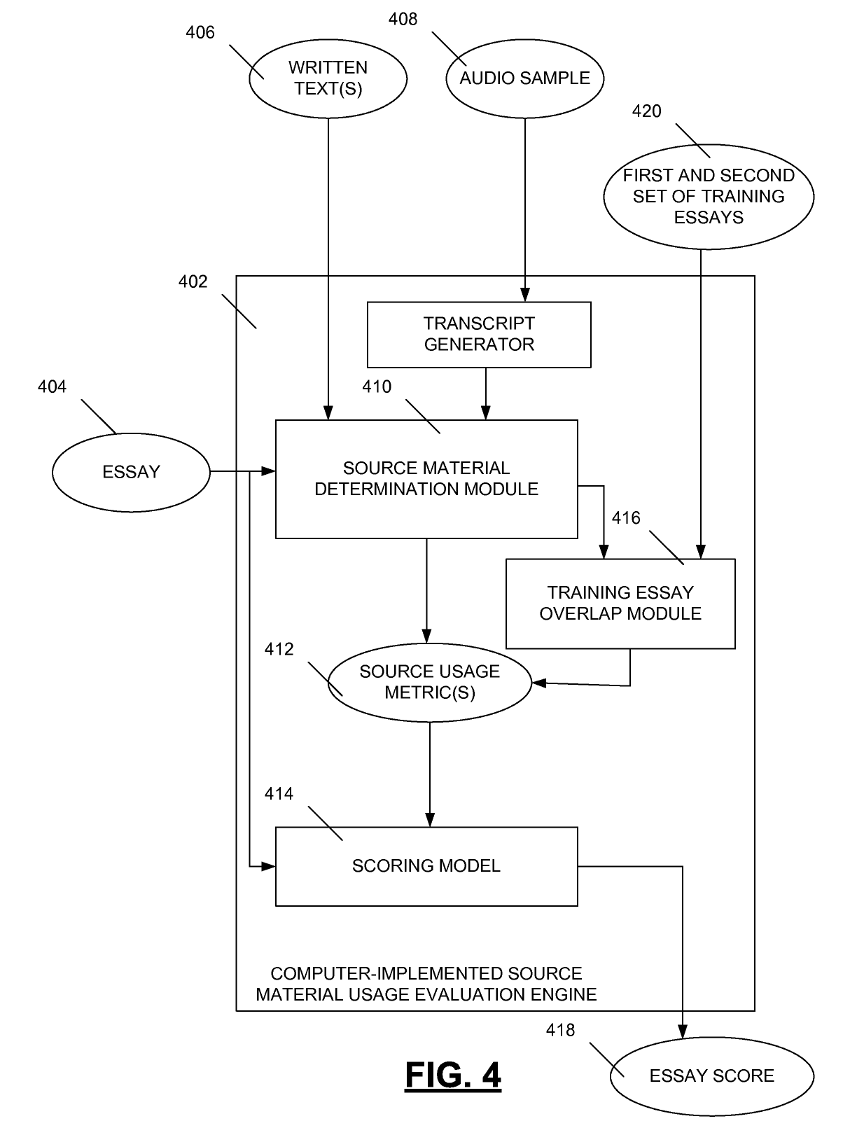

As noted above, the scoring model may transform one or more source usage metrics alone or in combination with other metrics into an essay score. FIG. 4 is a block diagram depicting a computer-implemented source material usage evaluation engine that transforms source usage metrics and metrics that take training essays into account into an essay score. The engine 402 receives an essay 404 for scoring and written text(s) 406 and an audio sample 408 provided to an examinee to elicit the essay 404. A transcript generator 410 extracts a transcript of speaking within the audio sample 408 that is provided along with the written texts 406 and the essay 404 to a source material determination module 410. As described with respect to FIG. 2, the source material determination module 410 evaluates overlap among n-grams of the essay 404, written texts 406, and the audio sample 408 transcript to determine a source usage metric 412 directly that is provided to the scoring model 414.

Additionally, a training essay overlap module 416 generates one or more metrics that are transformed in combination with the source usage metric(s) 412 generated by the source material determination module 410 by the scoring model 414 into the essay score 418. The training essay overlap module 416 receives one or more sets of training essays 420, such as human scored training responses to the same prompt that elicited the examinee essay 404. A first set of training essays 420 may be associated with high scoring essays (e.g., essays scoring 4 or 5), and a second set of training essays 420 are associated with low scoring essays (e.g., essays scoring 2; essays scoring 2 or 1). The source material determination module 410 indicates overlap of n-grams between the essay 404 and the written texts 406 and/or the audio sample 408. For those n-grams for which overlap is indicated, the training essay overlap module 416 determines one or more training essay metrics based on n-gram overlap of those indicated essay n-grams with n-grams in the one or more of the sets of training essays 420.

In one embodiment, the essay 404 or certain parameters describing the essay 404 (e.g., essay length) are provided to the scoring model for normalization or for generation of other scoring metrics.

Training essay metrics can take a variety of forms. The following indicates example source usage metrics:
A first training essay metric compares overlap of n-grams in the essay with n-grams in high scoring essays with overlap of those n-grams in the essay with n-grams in low scoring essays. In one embodiment, this training essay metric is determined using unigrams. In one example, the audio sample transcript 408 is represented as a set L of unigrams, the essay is represented as a list E of unigrams. A list B1 is determined as the list of unigrams from list E that are also in set L. The first training essay metric F3 is determined by initializing F3 to zero. For each unigram y in list B1, F3 is incremented by K, where K=(the proportion of training essays in the high scoring set that used unigram y)−(the proportion of training essays in the low scoring that use unigram y). F3 is then normalized by dividing F3 by the number of elements in list B1; and
A second training essay metric is based on an amount of overlap of n-grams in the essay with n-grams in the written texts and/or the audio sample. Those n-grams that overlap with source materials are then evaluated to determine whether they overlap with n-grams in the set of high scoring essays (e.g., n-grams that overlap with one or both of the source materials are counted and weighted according to the amount of times that those n-grams appear in high scoring essays of the training set 420). In one embodiment, this training essay metric is determined using unigrams or bigrams.

The operation of computer-implemented source material usage evaluation engines can be modified through selection of different sets of source usage metrics and training essay metrics to transform to generate an essay score. A computerized source usage scoring model includes various features (variables) that may be combined according to associated metric weights. For example, the computerized source usage model may be a linear regression model for which a source usage score is determined from a linear combination of weighted metrics. The values of the metric weights may be determined by training the computerized scoring model using a training corpus of essays (e.g., the training sets of essays depicted in FIG. 4) that have already been assigned source usage scores (e.g., by human scorers).

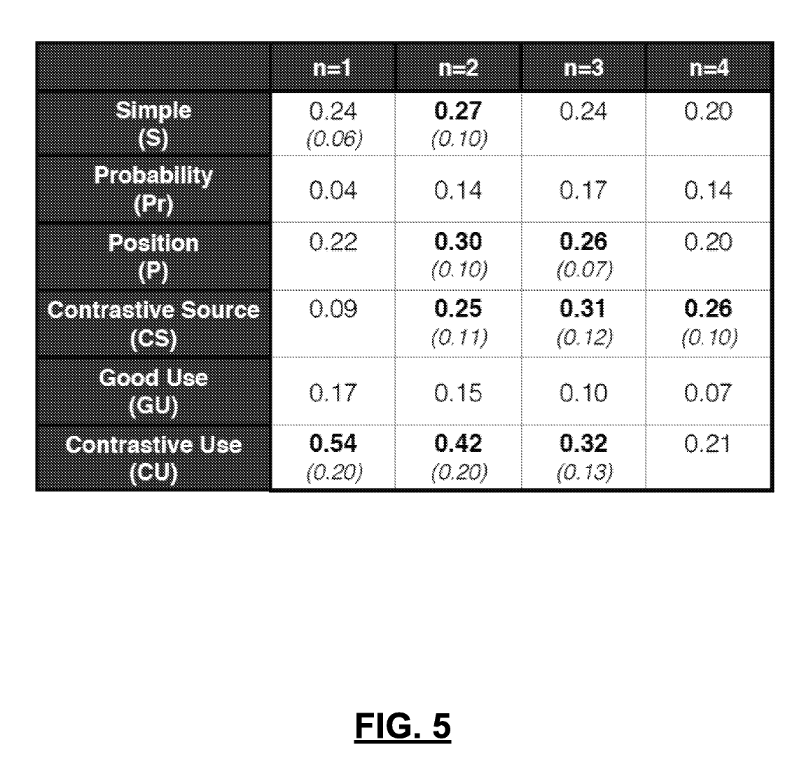

Engine operation can also be adjusted by modifying the n-gram size considered in generating the different source usage metrics and training essay metrics. FIG. 5 is a diagram depicting Pearson correlations between human provided scores and n-gram length for different source usage and training essay metrics. As shown in the experiment FIG. 5, different metrics were found to function best with different n-gram sizes. For example, the position metric, described as the fourth source usage metric above, was found in that experiment to operate best on bigrams or trigrams. In that same example, the contrastive source metric, described as the second source usage metric above, was found in that experiment to operate best on large n-grams, including quadgrams. N-gram sizes for metric determination, in one embodiment, could be adjusted on a per evaluation or even a per essay prompt basis, as best indicated by a training operation, in an attempt to implement a scoring model that most closely imitates human scoring behavior.

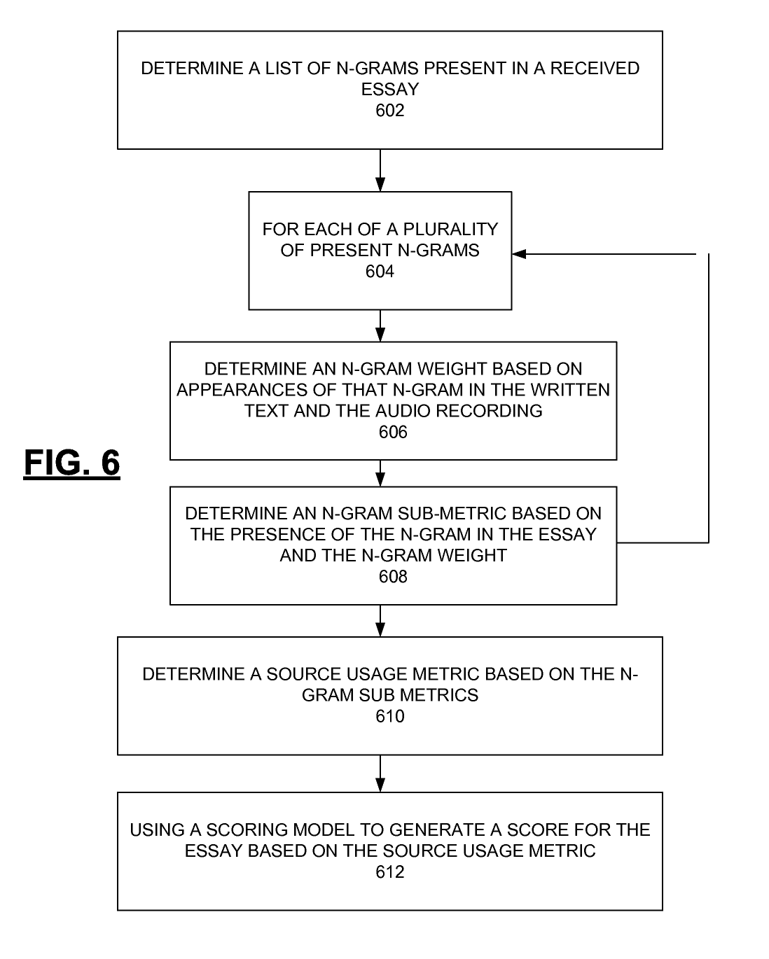

FIG. 6 is a flow diagram depicting a computer-implemented method of providing a score that measures an essay's usage of source material provided in at least one written text and an audio recording. At 602, a list of n-grams present in a received essay is determined with a processing system. At 604, for each of a plurality of present n-grams, a determination is made at 606 of an n-gram weight with the processing system, where the n-gram weight is based on a number of appearances of that n-gram in the at least one written text and a number of appearances of that n-gram in the audio recording, and at 608, an n-gram sub-metric is determined with the processing system based on the presence of the n-gram in the essay and the n-gram weight. At 610, a source usage metric is determined with the processing system based on the n-gram sub-metrics for the plurality of present n-grams, where the process at 606, 608, 610 repeats at this point. At 612, a scoring model is used to generate a score for the essay with the processing system based on the source usage metric, wherein the scoring model comprises multiple weighted features whose feature weights are determined by training the scoring model relative to a plurality of training texts.

The computerized approaches for scoring source usage described herein, which utilize, e.g., various computer models trained according to sample data, are very different from conventional human scoring of source usage in writing. In conventional human scoring of source usage, a human grader reads an essay with knowledge of associated source material and makes a holistic, mental judgment about its source usage and assigns a score. Conventional human grading of source usage does not involve the use of the computer models, associated variables, training of the models based on sample data to calculate weights of various features or variables, computer processing to parse the essay to be scored and representing such parsed essay with suitable data structures, and applying the computer models to those data structures to score the source usage of the text, as described herein.

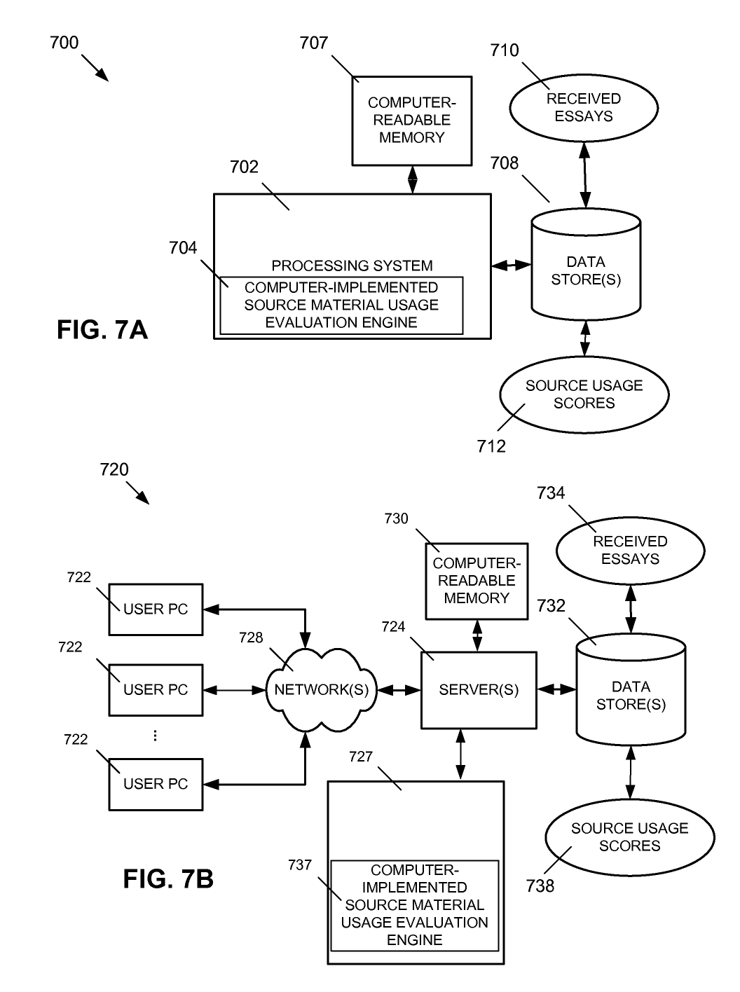

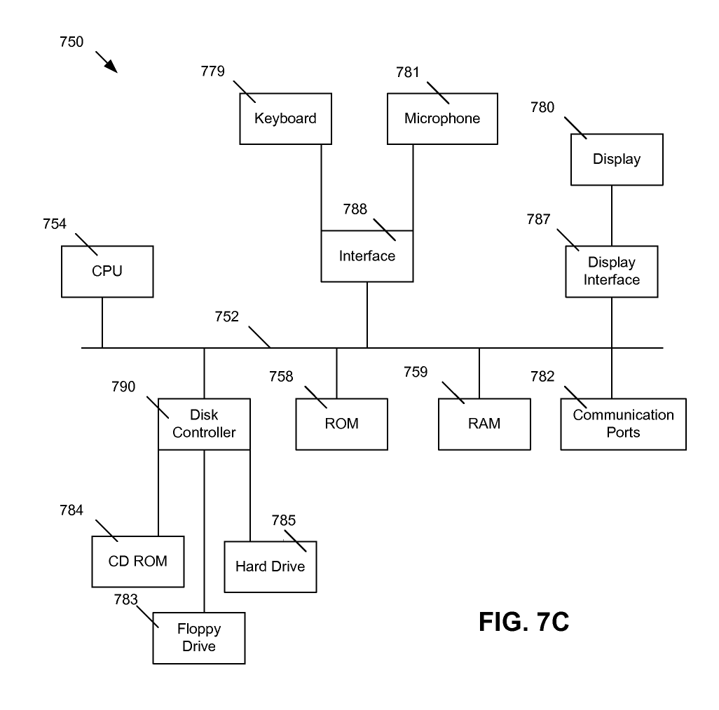

FIGS. 7A, 7B, and 7C depict example systems for implementing the approaches described herein for generating a source usage score for essays. For example, FIG. 7A depicts an exemplary system 700 that includes a standalone computer architecture where a processing system 702 (e.g., one or more computer processors located in a given computer or in multiple computers that may be separate and distinct from one another) includes a computer-implemented source material usage evaluation engine 704 being executed on the processing system 702. The processing system 702 has access to a computer-readable memory 707 in addition to one or more data stores 708. The one or more data stores 708 may include received essays 710 as well as source usage scores 712. The processing system 702 may be a distributed parallel computing environment, which may be used to handle very large-scale data sets.

FIG. 7B depicts a system 720 that includes a client-server architecture. One or more user PCs 722 access one or more servers 724 running a source material usage evaluation engine 737 on a processing system 727 via one or more networks 728. The one or more servers 724 may access a computer-readable memory 730 as well as one or more data stores 732. The one or more data stores 732 may include received essays 734 as well as source usage scores 738.

FIG. 7C shows a block diagram of exemplary hardware for a standalone computer architecture 750, such as the architecture depicted in FIG. 7A that may be used to include and/or implement the program instructions of system embodiments of the present disclosure. A bus 752 may serve as the information highway interconnecting the other illustrated components of the hardware. A processing system 754 labeled CPU (central processing unit) (e.g., one or more computer processors at a given computer or at multiple computers), may perform calculations and logic operations required to execute a program. A non-transitory processor-readable storage medium, such as read only memory (ROM) 758 and random access memory (RAM) 759, may be in communication with the processing system 754 and may include one or more programming instructions for performing the method of generating a source usage score for received essays. Optionally, program instructions may be stored on a non-transitory computer-readable storage medium such as a magnetic disk, optical disk, recordable memory device, flash memory, or other physical storage medium.

In FIGS. 7A, 7B, and 7C, computer readable memories 707, 730, 758, 759 or data stores 708, 732, 783, 784, 788 may include one or more data structures for storing and associating various data used in the example systems for generating a source usage score for received essays. For example, a data structure stored in any of the aforementioned locations may be used to store data from XML files, initial parameters, and/or data for other variables described herein. A disk controller 790 interfaces one or more optional disk drives to the system bus 752. These disk drives may be external or internal floppy disk drives such as 783, external or internal CD-ROM, CD-R, CD-RW or DVD drives such as 784, or external or internal hard drives 785. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 790, the ROM 758 and/or the RAM 759. The processor 754 may access one or more components as required.

A display interface 787 may permit information from the bus 752 to be displayed on a display 780 in audio, graphic, or alphanumeric format. Communication with external devices may optionally occur using various communication ports 782.

In addition to these computer-type components, the hardware may also include data input devices, such as a keyboard 779, or other input device 781, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

For example, in one embodiment essay scores are normalized based on vocabulary present in a prompt provided to an examinee to elicit the essay. In certain examples, such as TOEFL Independent, prompts differ in terms of the distinctiveness of the lecture vocabulary versus reading vocabulary, as well as in the extent to which the prompt keywords are easy to paraphrase. For example, the keywords in a prompt that deals with working in teams are easy to paraphrase (e.g., one could seamlessly paraphrase team with group), whereas the keywords in a prompt discussing hydroelectric dams leave less room for paraphrase (e.g., one could say blockage or obstruction instead of dam, but this is rather less likely). Because certain of the source usage metrics consider the vocabulary that is in the overlap between the lecture and the essay, those prompts for which paraphrase is less likely would tend to have more items in the overlap, and hence higher values for determined metrics, all else being equal.

To neutralize this effect in one embodiment, a system standardizes the source usage metrics by prompt, whenever possible. That is, the system estimates mean and standard deviation of the metric value per prompt using training essay data stored in a computer-readable medium. If there are no training essays for the given prompt in the data, the system fall backs to the overall mean and standard deviation that are calculated across all prompts in training data.

It is claimed:

1. A computer-implemented method of providing a score that measures an essay's usage of source material provided in at least one written text and an audio recording, comprising:
determining, with a processing system, a list of n-grams present in a received essay;
for each of a plurality of present n-grams:
determining an n-gram weight with the processing system, wherein the n-gram weight is based on a number of appearances of that n-gram in the at least one written text and a number of appearances of that n-gram in the audio recording;
determining an n-gram sub-metric with the processing system based on the presence of the n-gram in the essay and the n-gram weight, the n-gram sub-metric being indicative of a quality of usage of that n-gram that appears in the at least one written text or the audio recording;
determining a source usage metric with the processing system based on the n-gram sub-metrics for the plurality of present n-grams;
generating a score for the essay based on the source usage metric with the processing system based on a computer scoring model, wherein the scoring model comprises multiple weighted features whose feature weights are determined by training the scoring model relative to a plurality of training texts, wherein generating the score includes transforming the source usage metric into another numerical measure according to an associated feature weight.

2. The method of claim 1, wherein an n-gram is a string of n words.

3. The method of claim 2, wherein the n-gram weight for a particular n-gram is based on a difference between the number of times that the particular n-gram appears in the audio recording and the number of times that the particular n-gram appears in the at least one written text.

4. The method of claim 3, wherein the list of n-grams present in the received essay includes n-grams of four words in length.

5. The method of claim 1, wherein the scoring model generates the score based on a second metric.

6. The method of claim 5, wherein the second metric is based on occurrences of each of a second set of present n-grams in a first set of training essays and occurrences of each of the plurality of present n-grams in a second set of training essays, wherein the second set of present n-grams overlap with either the at least one written text or the audio recording.

7. The method of claim 6, wherein the first set of training essays contains essays having high scores assigned by human scorers, and wherein the second set of training essays contains essays having low scores assigned by human scorers.

8. The method of claim 7, wherein the first set of training essays and the second set of training essays are scored on a scale of 1-5, wherein the first set of training essays contains essays having scores of 4 or 5, and wherein the second set of training essays contains essays having a score of 2.

9. The method of claim 7, wherein the list of n-grams present in the received essay includes n-grams of one word in length.

10. The method of claim 5, wherein the second metric is based on occurrences of each of a second set of present n-grams in the audio recording and a length of the essay.

11. The method of claim 10, wherein the list of n-grams present in the received essay includes n-grams of two words in length.

12. The method of claim 5, wherein the second metric is based on:
a probability that particular n-grams present in the essay are in the audio recording; or
a position of particular n-grams present in the essay in the essay.

13. The method of claim 1, wherein the audio recording is an audio recording or a video recording of a person speaking.

14. The method of claim 13, further comprising generating a transcript of the audio recording, wherein the transcript is used in determining the number of appearances of that n-gram in the audio recording.

15. The method of claim 1, wherein the n-gram weight is determined by accessing the n-gram weight from a computer-readable data store.

16. The method of claim 1, wherein the n-gram weight is calculated in real time based on the identity of a current n-gram being evaluated.

17. The method of claim 1, further comprising normalizing the source usage metric based on vocabulary appearing in a prompt to elicit the received essay from a test taker.

18. The method of claim 1, wherein a prompt to elicit the received essay from a test taker instructs the test taker to summarize the audio recording and to contrast the audio recording with the at least one written text.

19. A computer-implemented system for providing a score that measures an essay's usage of source material provided in at least one written text and an audio recording, comprising:
a processing system comprising one or more data processors;
a computer-readable medium encoded with instructions for commanding the processing system to execute a method that includes:
determining a list of n-grams present in a received essay;
for each of a plurality of present n-grams:
determining an n-gram weight, wherein the n-gram weight is based on a number of appearances of that n-gram in the at least one written text and a number of appearances of that n-gram in the audio recording;
determining an n-gram sub-metric based on the presence of the n-gram in the essay and the n-gram weight, the n-gram sub-metric being indicative of a quality of usage of that n-gram that appears in the at least one written text or the audio recording;
determining a source usage metric based on the n-gram sub-metrics for the plurality of present n-grams;
generating a score for the essay based on the source usage metric based on a computer scoring model, wherein the scoring model comprises multiple weighted features whose feature weights are determined by training the scoring model relative to a plurality of training texts, wherein generating the score includes transforming the source usage metric into another numerical measure according to an associated feature weight.

20. The system of claim 19, wherein an n-gram is a string of n words.

21. The system of claim 20, wherein the n-gram weight for a particular n-gram is based on a difference between the number of times that the particular n-gram appears in the audio recording and the number of times that the particular n-gram appears in the at least one written text.

22. The system of claim 19, wherein the scoring model generates the score based on a second metric.

23. The system of claim 22, wherein the second metric is based on occurrences of each of a second set of present n-grams in a first set of training essays and occurrences of each of the plurality of present n-grams in a second set of training essays, wherein the second set of present n-grams overlap with either the at least one written text or the audio recording.

24. The system of claim 23, wherein the first set of training essays contains essays having high scores assigned by human scorers, and wherein the second set of training essays contains essays having low scores assigned by human scorers.

25. A computer-readable medium encoded with instructions for commanding one or more data processors to execute a method of providing a score that measures an essay's usage of source material provided in at least one written text and an audio recording, the method comprising:
determining a list of n-grams present in a received essay;
for each of a plurality of present n-grams:
determining an n-gram weight, wherein the n-gram weight is based on a number of appearances of that n-gram in the at least one written text and a number of appearances of that n-gram in the audio recording;
determining an n-gram sub-metric based on the presence of the n-gram in the essay and the n-gram weight the n-gram sub-metric being indicative of a quality of usage of that n-gram that appears in the at least one written text or the audio recording;
determining a source usage metric based on the n-gram sub-metrics for the plurality of present n-grams;
generating a score for the essay based on the source usage metric based on a computer scoring model, wherein the scoring model comprises multiple weighted features whose feature weights are determined by training the scoring model relative to a plurality of training texts, wherein generating the score includes transforming the source usage metric into another numerical measure according to an associated feature weight.
